(19) United States
(12) Patent Application Publication
(10) Pub. No.: US 2024/0250318 A1
(43) Pub. Date: Jul. 25, 2024

(54) ANTI-THEFT SYSTEM USING CURRENT CONTROLLED BOX

(71) Applicants: Nicola Cinagrossi, Uster (CH); Raghuram Devanur Chandrashekhariah, Kokomo, IN (US)

(72) Inventors: Nicola Cinagrossi, Uster (CH); Raghuram Devanur Chandrashekhariah, Kokomo, IN (US)

(73) Assignee: Green Cubes Technology, LLC, Kokomo, IN (US)

(21) Appl. No.: 18/562,172

(22) PCT Filed: May 17, 2021
(86) PCT No.: PCT/US2021/032780

§ 371 Date: Nov. 17, 2023

(51) Int. Cl. H01M 10/42; G01S 19/16; H01M 50/258

(52) U.S. Cl. CPC H01M 10/425; G01S 19/16; H01M 50/258; H01M 2010/4271

(57) ABSTRACT

Disclosed herein are anti-theft battery systems and methods to reduce theft of expensive batteries, such as may be used as a backup power source in communication systems. These anti-theft battery systems include a battery having a BMS, current control circuit, and/or GPS. The battery may also be coupled to a system controller. These anti-theft battery systems allow the battery charge/discharge current to be controlled via a current control circuit within the battery, such as whenever communication is lost between the battery and the system controller, and/or whenever a GPS tracker within the battery indicates a change of location, and/or whenever the battery is connected/disconnected to/from a load. Whenever the current control circuit detects one of these changes in condition, it resets the charge/discharge current to low power, or voltage, such as less than 1%, thus making the battery useless and unable to perform charging and discharging, thus deterring theft.

### BACKGROUND

In telecom base stations and other communication systems, batteries are widely used as a back-up power source to prevent service interruption. Any service interruption of a communication system is highly undesirable and can adversely affect a large number of people and may also hinder emergency services. In some communication systems, the telecom base stations may be located in remote areas which are difficult to access. These remote areas may take time to reach or access and likely may be not checked and/or accessed by staff regularly. These remote locations have, unfortunately, become a target for thieves due to the high value of the back-up batteries.

Because of the high value of back-up batteries, anti-theft technologies and methods have been developed to help solve this problem. Some anti-theft methods use a reinforced mechanical infrastructure to try to prevent theft, but this solution has only extended the time needed for thieves to access the battery. Another anti-theft method involves having a channel connected to an alarm system, but unfortunately, this technique is overcome by thieves removing the signal channel from the system. These anti-theft methods have not provided an effective solution to the theft, and thus customers are still adversely affected by service outages in communication systems. Due to the drawbacks of the currently available anti-theft technologies and methods, it would certainly be desirable to develop a more effective anti-theft system to protect the valuable back-up batteries in electric vehicles, communication systems, and other systems to prevent undesirable service outages and inconvenience to consumers.

### BRIEF SUMMARY OF THE INVENTION

The present disclosure includes disclosure of a battery anti-theft system, comprising: a battery pack having a timer and a current control circuit for adjusting charge and/or discharge limits of the battery; and a system controller in operable communication with the battery pack; wherein the battery pack's charge and/or discharge limits are reset and limited to low charge and/or discharge levels to render the battery useless and prevent or deter theft, whenever: i) a predefined condition is met, and ii) the timer has expired.

The present disclosure also includes disclosure of a system, wherein the predefined condition is loss of communication between the battery pack and the system controller.

The present disclosure also includes disclosure of a system, wherein the battery pack's charge and/or discharge limits are reset to restore the battery pack's normal charge and/or discharge levels if communication is restored between the battery pack and the system controller.

The present disclosure also includes disclosure of a system, wherein: the battery pack further comprises a GPS tracker; and the predefined condition is movement of the battery pack out of a predefined area or zone determined by the GPS tracker.

The present disclosure also includes disclosure of a system, wherein the battery pack's charge and/or discharge limits are reset to restore the battery pack's normal charge and/or discharge levels if the GPS tracker indicates the battery pack is within the predefined area or zone.

The present disclosure also includes disclosure of a system, wherein the predefined condition is change of an intended load upon the battery pack.

The present disclosure also includes disclosure of a system, wherein the battery pack's charge and/or discharge limits are reset to restore the battery pack's normal charge and/or discharge levels if the intended load is restored.

The present disclosure also includes disclosure of a system, wherein the battery pack further comprises a battery management system (BMS) and/or communication system.

The present disclosure also includes disclosure of a system, wherein the battery pack's charge and/or discharge limits are reset to restore the battery pack's normal charge and/or discharge levels if an encrypted message is received from the system controller.

The present disclosure also includes disclosure of a system, wherein the timer is a counter or count-down timer and is utilized to avoid false triggering of the anti-theft system.

The present disclosure also includes disclosure of a system, further comprising a second battery pack, and wherein the system is modular and the first and second battery packs may be used in parallel.

The present disclosure also includes disclosure of a system, wherein the battery pack is swappable and removable for recharging.

The present disclosure also includes disclosure of a method for preventing theft of a battery, comprising: providing the battery anti-theft system of claim 1, comprising: determining if the predetermined condition is met; starting a timer if it is determined that the predetermined condition has been met; and adjusting the charge and/or discharge limits once the timer expires, unless the predefined condition has not been met.

The present disclosure also includes disclosure of a battery anti-theft system, comprising: a plurality of battery packs, each of the plurality of battery packs having a timer, a GPS tracker, and a current control circuit for adjusting charge and/or discharge limits of the battery pack; and a system controller in operable communication with each one of the plurality of battery packs; wherein at least one of the plurality of battery pack's charge and/or discharge limits are reset and limited to low charge and/or discharge levels to render the battery useless and prevent or deter theft whenever the timer within the at least one of the plurality of battery pack's has expired and: i) communication is lost between the system controller and any one of the plurality of battery packs, or ii) the GPS tracker in any one of the plurality of battery packs indicates a change of location; or iii) a change is detected in an intended load on any one of the plurality of battery packs.

The present disclosure also includes disclosure of a system wherein the system is modular and the plurality of battery packs may be used in parallel and are swappable and removable for recharging.

The present disclosure also includes disclosure of a method for preventing theft of a battery, comprising: providing a battery anti-theft system, comprising: a battery pack having a timer and a current control circuit for adjusting charge and/or discharge limits of the battery; and a system controller in operable communication with the battery pack; wherein the battery pack's charge and/or discharge limits are reset and limited to low charge and/or discharge levels to render the battery useless and prevent or deter theft, whenever: i) a predefined condition is met, and ii) the timer has expired; determining if communication is lost between the battery pack and the system controller; starting a timer if it is determined that the communication is lost between the battery pack and the system controller; and adjusting the charge and/or discharge limits of the battery pack to low levels to render the battery useless and prevent or deter theft once the timer expires, unless the communication between the battery pack and the system controller is restored.

The present disclosure also includes disclosure of a method, further comprising restoring the battery pack's normal charge and/or discharge limits if the communication between the battery pack and the system controller is restored.

The present disclosure also includes disclosure of a method, further comprising rechecking status of the communications between the battery pack and the system controller before adjusting the charge and/or discharge limits of the battery pack to low levels, to avoid false triggering of the anti-theft system.

The present disclosure also includes disclosure of a method, wherein starting a timer may comprise starting a countdown lasting several days, to ensure adequate recharging time for the battery pack without false triggering of the anti-theft system.

The present disclosure also includes disclosure of a method, wherein the battery pack may further comprise a GPS tracker and wherein starting a timer may comprise starting a timer if the GPS tracker detects a change of location out of a predefined area.

### BRIEF DESCRIPTION OF THE DRAWINGS

The disclosed embodiments and other features, advantages, and disclosures contained herein, and the matter of attaining them, will become apparent and the present disclosure will be better understood by reference to the following description of the present disclosure taken in conjunction with the accompanying drawings, wherein:

FIG. 1 illustrates a perspective view of a back-up battery connected to a system controller within a cabinet;

FIG. 2 illustrates a schematic block diagram of parallel batteries in communication with a system controller; and

FIG. 3. illustrates a flow chart of an anti-theft method for the back-up batteries.

As such, an overview of the features, functions and/or configurations of the components depicted in the figures will now be presented. It should be appreciated that not all of the features of the components of the figures are necessarily described and some of these non-discussed features (as well as discussed features) are inherent from the figures themselves. Other non-discussed features may be inherent in component geometry and/or configuration. Furthermore, wherever feasible and convenient, like reference numerals are used in the figures and the description to refer to the same or like parts or steps. The figures are in a simplified form and not to precise scale.

### DETAILED DESCRIPTION

For the purposes of promoting an understanding the principles of the present disclosure, reference will now be made to the embodiments illustrated in the drawings, and specific language will be used to describe the same. It will nevertheless be understood that no limitation of the scope of this disclosure is thereby intended.

Disclosed herein are anti-theft battery systems and methods to reduce theft of expensive batteries. These expensive batteries may be used in electric vehicles, communication systems, data centers, telecom systems, AGV, GSE, forklifts, electric golf cars, diagnostic imaging devices (e.g. medical carts, CT, X-Ray endoscopes, ultrasound devices, electric bicycles, electric motorcycle, cleaning machines, food and beverage carts, as well as many others.

These anti-theft battery systems may include, at least, a battery 100 coupled to a system controller 200, and a GPS tracker to track location of the battery. These anti-theft battery systems may allow the battery charge/discharge current to be controlled via a current control circuit 102 within the battery 100, such as whenever communication is lost between the battery 100 and the system controller 200, and/or whenever a GPS tracker within the battery 100 indicates a change of location, and/or whenever the battery 100 is connected/disconnected to/from an intended load. Whenever the current control circuit 102 detects one of these events, or another preprogrammed change in condition, it may then set the charge/discharge current to a very low power, or voltage, such as less than 1%, thus making the battery useless as it will be unable to perform charging and discharging activity in a satisfactory way, thus deterring theft. In other embodiments, the charge/discharge current may be set to any low or unusable value, and/or a zero value, and/or otherwise blocked, and/or reconfigured, so as to also render the battery useless, thus deterring theft.

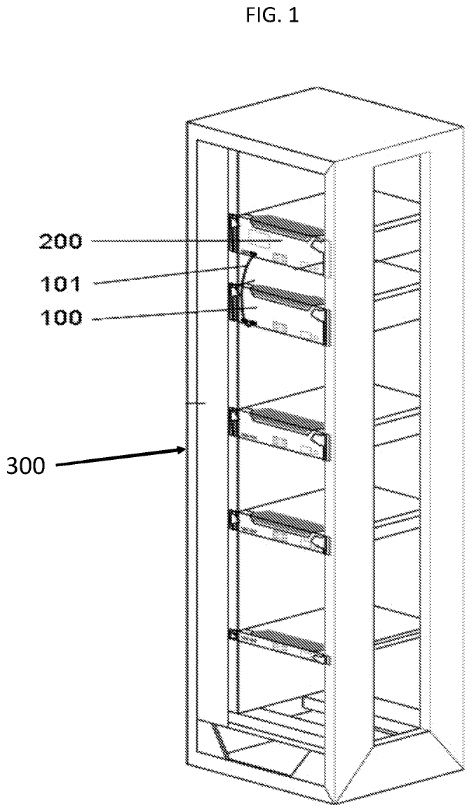

FIG. 1 illustrates an exemplary embodiment of a back-up battery 100 connected to a system controller 200, installed in a cabinet 300 such as for telecom and data centers applications. The battery 100 may be in operable communication with the system controller 200 via a network connection cable 101, such as a communication bus. The system controller 200 may continuously send and receive data with the battery 100 via the network connection cable 101, such that communication is maintained. In this embodiment, whenever the connection (such as via connection cable 101) is lost between the battery 100 and the system controller 200, the battery's charge and/or discharge limits may then be reduced to a low value, such as only 1% of the battery's normal charge and/or discharge limits, to render the battery 100 unusable. In another embodiment, the connection and/or communication between the battery 100 and the system controller 200 may be a wireless connection, such as through a signal transmitter and/or receiver, and/or through WiFi communications. In this embodiment, battery 100 and/or its BMS, may also include a receiver for wireless/WiFi signal communication with the system controller 200, or other controller and/or processor.

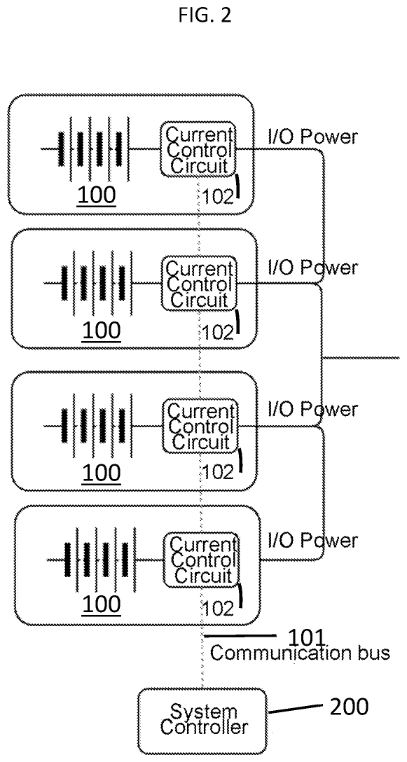

FIG. 2 illustrates multiple batteries 100 connected in parallel and in communication with a system controller 200 via a network connection cable 101, such as a communication bus. Each battery 100 may include a battery management system (BMS), and/or a GPS, and/or a current control circuit 102 that controls and/or resets the charge and discharge current limits (I/O power limits) for the battery 100. When the battery 100 is separated from, or loses communications with, the system controller 200 (i.e., if the communication bus 101 is disconnected), the communication signal will be interrupted. When the communication signal is interrupted between the battery 100 and the system controller 200, a count-down timer may begin. Once the count-down timer ends, the current control circuit 102 within the battery 100 may then reset and/or adjust the charge and/or discharge current limits to a low value, thus limiting the input/output power of the battery 100 and making the battery 100 unusable. Once the input/output power of the battery 100 is limited, the battery 100 will be worthless since it can no longer perform charging or discharging properly. However, if the count-down timer does not expire, or if the connection is restored between the battery 100 and the system controller 200, then the current control circuit 102 may enable the battery 100 to resume its normal operations at normal input/output power.

In another embodiment, the battery 100 may have a GPS tracker therein. Once the battery 100 is installed at a site, the system controller 200 may then be programmed with the battery 100 site's GPS location. This programmed GPS site location of the battery 100 may then be used to determine if the battery 100 remains at the site, or if the battery 100 is moved, such as during theft. If the battery 100 is moved away from the site, or out of the programmed GPS site location, then the current control circuit 102 may set the charge/discharge current to very low value, power, or voltage, for example less than 1% (after a specified time) to render the battery unusable.

In another embodiment, the battery 100 may also be programmed with an expected power or load profile, such as via its BMS, which may then be monitored by the battery 100 to check if the system is connected to an intended load. This embodiment may be useful in cycling applications when the batteries 100 are regularly charged and discharged, for example. If the battery detects that it is no longer connected to an intended load, then the battery 100 may begin a timer. If the timer expires and the battery 100 is still not connected to an intended load, then the current control circuit 102 may set the charge/discharge current to very low value, such as less than 1%. The battery 100 charge and discharge current limits will reset only if the battery 100 is reconnected to the intended load and/or to system controller 200. For example, the system controller 200 may send an encrypted message to allow the battery 100 to reset the charge and discharge limits to normal operating values if the battery 100 detects that it has been reconnected to the system controller 200, and/or reconnected to an intended load, and/or is detected as being within a designated GPS site location.

In some embodiments, the battery 100 may have a timer or counter to begin a count-down between the communication loss and the charge/discharge current limiting adjustment to avoid false triggering of the anti-theft system. In some examples, the time-period between the communication loss and the charge/discharge current limiting adjustment may be between 1 and 165 days, for example. The timer and/or counter may also allow time for a user to discharge the batteries 100 in the system if communication is lost. In some embodiments, the battery 100 may also send a signal to recheck the communication and/or connection between the battery 100 and the system controller 200 before the charge/discharge current is limited to further ensure the anti-theft system is not inadvertently triggered.

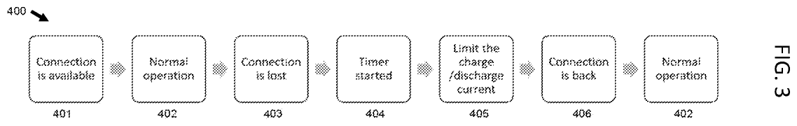

FIG. 3 illustrates a flow chart 400 of an exemplary embodiment of a method 400 of operating a battery anti-theft system. In an exemplary method 400 of operation, the battery 100 may operate normally 402 as long as the connection is available 401 and/or maintained between the back-up battery 100 and the system controller 200. However, once the connection 401 between the battery 100 and the system controller 200 is lost 403, a timer 404 or other countdown mechanism may be started. The timer 404 may be programmed to count to/for a specific time to then recheck the connection 401 status. If the connection 401 between the battery 100 and the system controller 200 is not resolved by the expiration of the timer 404, then the charge/discharge limits 405 of the battery 100 may be reduced to a very low limit until the connection 404 and/or communication is restored 406 to resume the battery's 100 normal operation 402.

Examples of the system controller 200 and/or the BMS may include, but are not limited to, a general processor, a central processing unit, logical CPUs/arrays, a microcontroller, an application specific integrated circuit (ASIC), a digital signal processor, a field programmable gate array (FPGA), and/or a digital circuit, analog circuit, or some combination thereof. In some embodiments, the system controller 200 may be one or more devices operable to execute logic. The logic may include computer executable instructions or computer code stored in memory that when executed by a processor and/or the system controller 200, causes the battery 100 and/or the system controller 200 to perform the operations described herein above to activate the anti-theft system.

While various embodiments of devices and systems and methods for using the same have been described in considerable detail herein, the embodiments are merely offered as non-limiting examples of the disclosure described herein. It will therefore be understood that various changes and modifications may be made, and equivalents may be substituted for elements thereof, without departing from the scope of the present disclosure. The present disclosure is not intended to be exhaustive or limiting with respect to the content thereof.

Further, in describing representative embodiments, the present disclosure may have presented a method and/or a process as a particular sequence of steps. However, to the extent that the method or process does not rely on the particular order of steps set forth therein, the method or process should not be limited to the particular sequence of steps described, as other sequences of steps may be possible. Therefore, the particular order of the steps disclosed herein should not be construed as limitations of the present disclosure. In addition, disclosure directed to a method and/or process should not be limited to the performance of their steps in the order written. Such sequences may be varied and still remain within the scope of the present disclosure.

1. A battery anti-theft system, comprising:
a battery pack having a timer and a current control circuit for adjusting charge and/or discharge limits of the battery; and
a system controller in operable communication with the battery pack;
wherein the battery pack's charge and/or discharge limits are reset and limited to low charge and/or discharge levels to render the battery useless and prevent or deter theft, whenever: i) a predefined condition is met, and ii) the timer has expired.

2. The system of claim 1, wherein the predefined condition is loss of communication between the battery pack and the system controller.

3. The system of claim 2, wherein the battery pack's charge and/or discharge limits are reset to restore the battery pack's normal charge and/or discharge levels if communication is restored between the battery pack and the system controller.

4. The system of claim 1, wherein:
the battery pack further comprises a GPS tracker; and
the predefined condition is movement of the battery pack out of a predefined area or zone determined by the GPS tracker.

5. The system of claim 4, wherein the battery pack's charge and/or discharge limits are reset to restore the battery pack's normal charge and/or discharge levels if the GPS tracker indicates the battery pack is within the predefined area or zone.

6. The system of claim 1, wherein the predefined condition is change of an intended load upon the battery pack.

7. The system of claim 6, wherein the battery pack's charge and/or discharge limits are reset to restore the battery pack's normal charge and/or discharge levels if the intended load is restored.

8. The system of claim 1, wherein the battery pack further comprises a battery management system (BMS) and/or communication system.

9. The system of claim 1, wherein the battery pack's charge and/or discharge limits are reset to restore the battery pack's normal charge and/or discharge levels if an encrypted message is received from the system controller.

10. The system of claim 1, wherein the timer is a counter or count-down timer and is utilized to avoid false triggering of the anti-theft system.

11. The system of claim 1 further comprising a second battery pack, and wherein the system is modular and the first and second battery packs may be used in parallel.

12. The system of claim 1, wherein the battery pack is swappable and removable for recharging.

13. A method for preventing theft of a battery, comprising:
providing the battery anti-theft system of claim 1, comprising:
determining if the predetermined condition is met;
starting a timer if it is determined that the predetermined condition has been met; and
adjusting the charge and/or discharge limits once the timer expires, unless the predefined condition has not been met.

14. A battery anti-theft system, comprising:
a plurality of battery packs, each of the plurality of battery packs having a timer, a GPS tracker, and a current control circuit for adjusting charge and/or discharge limits of the battery pack; and
a system controller in operable communication with each one of the plurality of battery packs;
wherein at least one of the plurality of battery pack's charge and/or discharge limits are reset and limited to low charge and/or discharge levels to render the battery useless and prevent or deter theft whenever the timer within the at least one of the plurality of battery pack's has expired and: i) communication is lost between the system controller and any one of the plurality of battery packs, or ii) the GPS tracker in any one of the plurality of battery packs indicates a change of location; or iii) a change is detected in an intended load on any one of the plurality of battery packs.

15. The system of claim 1, wherein the system is modular and the plurality of battery packs may be used in parallel and are swappable and removable for recharging.

16. A method for preventing theft of a battery, comprising:
providing a battery anti-theft system, comprising:
a battery pack having a timer and a current control circuit for adjusting charge and/or discharge limits of the battery; and
a system controller in operable communication with the battery pack;
wherein the battery pack's charge and/or discharge limits are reset and limited to low charge and/or discharge levels to render the battery useless and prevent or deter theft, whenever: i) a predefined condition is met, and ii) the timer has expired;
determining if communication is lost between the battery pack and the system controller;
starting a timer if it is determined that the communication is lost between the battery pack and the system controller; and
adjusting the charge and/or discharge limits of the battery pack to low levels to render the battery useless and prevent or deter theft once the timer expires, unless the communication between the battery pack and the system controller is restored.

17. The method of claim 16, further comprising restoring the battery pack's normal charge and/or discharge limits if the communication between the battery pack and the system controller is restored.

18. The method of claim 16, further comprising rechecking status of the communications between the battery pack and the system controller before adjusting the charge and/or discharge limits of the battery pack to low levels, to avoid false triggering of the anti-theft system.

19. The method of claim 16, wherein starting a timer may comprise starting a countdown lasting several days, to ensure adequate recharging time for the battery pack without false triggering of the anti-theft system.

20. The method of claim 16, wherein the battery pack may further comprise a GPS tracker and wherein starting a timer may comprise starting a timer if the GPS tracker detects a change of location out of a predefined area.
